(19) United States
(12) Patent Application Publication
(10) Pub. No.: US 2009/0248242 A1
(43) Pub. Date: Oct. 1, 2009

(54) AIR DEFLECTORS ADJUSTABLE IN RESPONSE TO AIR DRAG

(75) Inventors: Samuel L. Cohen, Fort Wayne, IN (US); Matthew M. Sullivan, St. Joe, IN (US)

Correspondence Address: International Truck Intellectual Property Company,, 4201 WINFIELD ROAD, WARRENVILLE, IL, 60555, US

(73) Assignee: International Truck Intellectual Property Company LLC, Warrenville, IL (US)

(21) Appl. No.: 12/056,996

(22) Filed: Mar. 27, 2008

(51) Int. Cl. G06F 7/00

(52) U.S. Cl. 701/36

(57) ABSTRACT

A method of changing the aerodynamic drag on a vehicle (14) having at least one adjustable air deflector (10, 110, 30, 46) includes disposing an air drag sensor (50) on an outside surface of the vehicle to measure an air drag value “Value”, comparing the air drag value with a predetermined value “y”, and adjusting the air deflector when the air drag value is either less than or less than or equal to the predetermined value.

### FIELD OF THE INVENTION

The present invention relates generally to automotive air deflectors. More specifically, the present invention relates to air deflectors that are adjustable in response to air drag.

### BACKGROUND OF THE INVENTION

The drag on a tractor trailer truck significantly reduces the fuel efficiency of the vehicle. One area where significant drag is created is at a gap located between the tractor and the trailer. This gap is typically 36 to 48 inches, depending on the vehicle and depending on the amount of loading on the trailer. The larger the gap, the more air that is trapped in the gap, and the more drag that is created on the vehicle.

Fixed air deflectors are commonly used to reduce the gap distance, and in turn, reduce the drag. The fixed air deflector is typically a rigid, planar panel that extends lengthwise with respect to the vehicle along at least a portion of the gap distance between the tractor and the trailer. However, the fixed air deflector does not extend the entire gap distance because allowances between the extender and the trailer must be made to accommodate for the tractor turning relative to the trailer.

Air deflectors are also disposed on top of the cab, and are called roof air deflectors. Fixed roof air deflectors may improve the air drag in some situations, however they do not improve air drag in every situation since each cab may be used with different trailers, and each combination of cab to trailer may have a different trailer-to-cab distance, width and height.

Further, while fixed air deflectors are designed in a wind tunnel for front headwinds only, road air drag conditions are constantly changing. A particular air deflector design may address air drag under a headwind condition, but may not address air drag under actual road conditions.

### SUMMARY OF THE INVENTION

A method of changing the aerodynamic drag on a vehicle having at least one adjustable air deflector includes disposing an air drag sensor on an outside surface of the vehicle to measure an air drag value, comparing the air drag value with a predetermined value, and adjusting the air deflector when the air drag value is either less than or less than or equal to the predetermined value.

### BRIEF DESCRIPTION OF THE DRAWINGS

FIG. 1 is a partially exploded, perspective view of a roof air deflector in a retracted position in accordance with the invention.

FIG. 2 is a partially exploded, perspective view of the roof air deflector in an extended position in accordance with the invention.

FIG. 3 is a partially exploded, perspective view of an alternative embodiment of a roof air deflector in a retracted position in accordance with the invention.

FIG. 4 is a partially exploded, perspective view of the alternative embodiment of a roof air deflector in an extended position in accordance with the invention.

FIG. 5 is an exploded, perspective view of a side air deflector in an extended position in accordance with the invention.

FIG. 6 is an exploded, perspective view of the side air deflector with a supplemental air deflector in an extended position in accordance with the invention.

FIG. 7 is a flow diagram of the method of adjusting the air deflectors in accordance with the invention.

### DESCRIPTION OF A PREFERRED EMBODIMENT

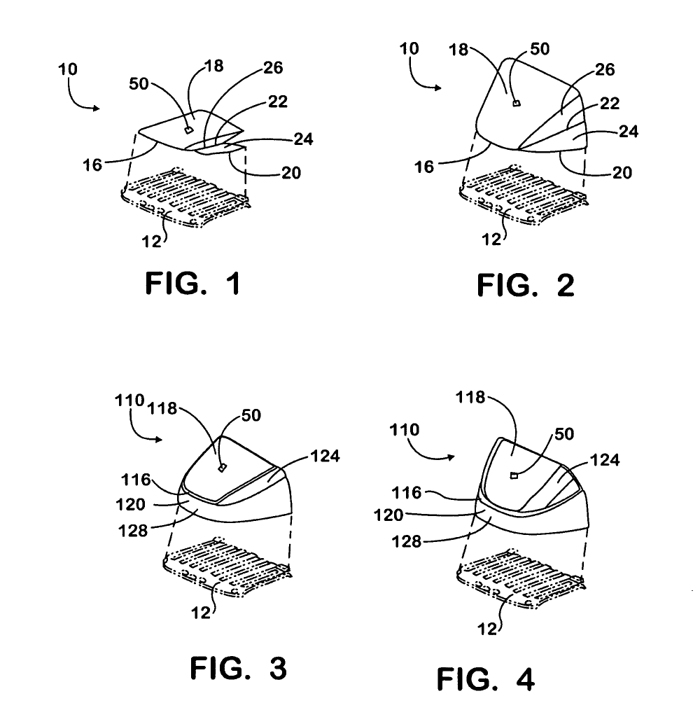

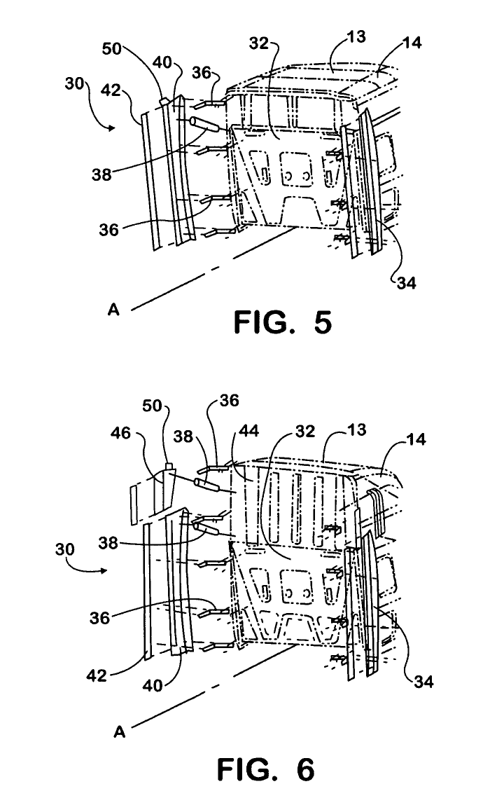

Referring to FIGS. 1-2, an adjustable roof air deflector is depicted generally at 10, and is configured to be attached to a top surface 12 of a tractor 13 (FIG. 5) of a truck (not shown). While the present adjustable air deflector 10 is described with respect to a tractor and trailer type vehicle 14 (FIG. 5), it is contemplated that the air deflector can be used on other vehicles.

The adjustable roof air deflector 10 has a first hinge 16 at the junction of a top surface 18 and a bottom surface 20, a second hinge 22 at a first side surface 24 and a second side surface 26. A third hinge (not shown) is located opposite of the second hinge 22 to allow the top surface 18 to pivot relative to the bottom surface 20. In FIG. 1, the adjustable roof air deflector 10 is pivoted downwards with respect to the bottom surface 20 in a retracted position. In FIG. 2, the top surface 18 is pivoted upwards with respect to the bottom surface 20 in an extended position.

A second embodiment of roof air deflector 110 is shown in FIGS. 3-4. The roof air deflector 110 has a stationary base 128 that is configured to be attached to a top surface 12 of the tractor 13 (FIG. 5). The adjustable roof air deflector 110 has a first hinge 116 at the junction of a top surface 118 and a front surface 120 of the base 128. A side surface 124 telescopes and the top surface 118 pivots with respect to the stationary base 128 to position the roof air deflector 110 into the extended position of FIG. 4. In the retracted position of FIG. 3, the top surface 118 is pivoted towards the stationary base 128.

The roof air deflector 10 and 110 are advantageously operated with electric motors run by servos, however other methods of operation are contemplated. The roof air deflector 10 and 110 are advantageously formed of hard, closed foam substrate, however other materials are contemplated. The hard, closed foam substrate allows the deflectors to be crushable, without damaging the rest of the vehicle 14.

As is known in the art, each side air deflector 30 is attached to the back surface 32 of the tractor 13 and is substantially parallel to a longitudinal axis “A” of the vehicle 14 to enclose a portion of the gap between the tractor and trailer (not shown). The side air deflector 30 is advantageously formed of hard, closed cell foam substrate, however other materials are contemplated.

The side air deflector 30 has a length that spans a portion of the gap between a front surface of the trailer and the tractor 13. To minimize drag, each side air deflector 30 is oriented to direct the airflow from the tractor 13 along an outer surface 34 of the deflector and back towards a side surface of the trailer (not shown). In a first position, the side air deflector 30 leaves a clearance between the side air deflector and the trailer. The clearance permits the tractor 13 to pivot with respect to the trailer without the trailer contacting the side air deflector.

The side air deflector 30 is movable on at least one hinge 36 to extend towards the trailer (to reduce the gap between the tractor 13 and trailer). The side air deflector 30 is actuated with at least one actuator 38 to position the side air deflector towards or away from the trailer along the longitudinal axis “A” (to open or close the distance between the tractor 13 and trailer). Further, the side air deflector 30 is actuated with at least one actuator 38 to pivot the deflector inwards towards the longitudinal axis “A” or outwards away from the longitudinal axis “A”. It is contemplated that the actuator 38 can be any kind of actuator such as a hydraulic, pneumatic or magnetic actuator. Further, it is contemplated that the actuator 38 can be actuated with a motor, gearbox, wiring, and any other mechanical or electrical devices.

It is contemplated that the height of the side air deflector 30 is generally equal to the height of the tractor 13 and/or the trailer. Further, the side air deflector 30 advantageously includes a main panel 40 and a generally thin, trim strip 42 that is configured to deflect air current.

Referring now to FIG. 6, the tractor 13 includes a high-rise roof 44 that has a height that is higher than the height of the side air deflector 30. A supplemental air deflector 46 is disposed on top of the side air deflector 30 and is operated in generally the same way as the side air deflector. Together, the side air deflector 30 and the supplemental air deflector 46 have a height generally corresponding to the height of the high-rise roof 44.

Referring to FIGS. 1-6, the air deflectors 10, 110, 30 and 46 selectively reciprocate to change the aerodynamic drag of the vehicle 14 in response to at least one air drag sensor 50 disposed on at outside surface of the vehicle. The air drag sensor 50 measures the air drag on the vehicle 14, and sends the measurement to an air drag indicator 52 located in the tractor 13 to inform the driver of the amount of air drag on the vehicle. It is contemplated that the air drag indicator 52 is an LED display. Further, the air drag sensor 50 constantly or periodically measures the air drag on the vehicle 14 while the vehicle is in motion.

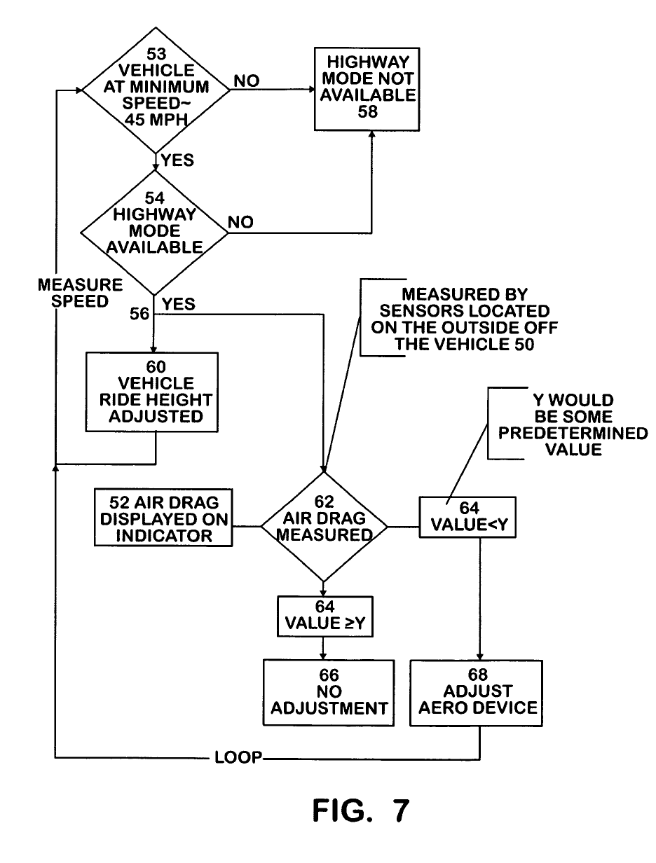

A flow diagram of the method of adjusting the air deflectors 10, 110, 30, 46 is shown in FIG. 7. The air deflectors 10, 110, 30, 46 are adjusted in response to the constant or periodic air drag measurements taken while the vehicle 14 is in motion. When the vehicle 14 reaches a minimum speed (step 53), for example 45 miles per hour, the adjustment or “highway mode” is available to the driver (step 54). The driver can either switch the “highway mode” on (step 56) or not switch the “highway mode” on (step 58). If the “highway mode” is switched on (step 56), then the vehicle ride height is adjusted (step 60) to a predetermined amount or is adjustable with respect to vehicle 14 speed. For example, the ride height of the tractor 13 may be lowered two inches, or may be lowered anywhere between one and three inches depending on the speed of the vehicle 14.

When the “highway mode” is turned on (step 56), the air drag is measured by the at least one air drag sensor 50 (step 62). The air drag is assigned a value “Value”, such as between 1 and 10, with 10 being the most desirable amount of air drag, although it is contemplated that other air drag value assignments can be made. The air drag value “Value” is compared with a predetermined value “y” (step 64). If the value of the air drag “Value” is greater than or equal to “y”, then no adjustment is made to the air deflectors 10, 110, 30, 46 (step 66). If the value of the air drag “Value” is less than “y”, then adjustments are automatically or manually made to the air deflectors 10, 110, 30, 46 while the vehicle 14 is in motion (step 68). The adjustment method loops as long as the vehicle 14 maintains the predetermined minimum speed (step 53). In this configuration, the air deflectors 10, 110, 30, 46 can constantly or periodically adjust in response to changes in air drag and speed when the vehicle speed is at least the minimum speed.

In response to the air drag value “Value”, any or all of the air deflectors 10, 110, 30, 46 are selectively adjustable. It is contemplated that when the transmission of the vehicle 14 is downshifted, when the brakes are applied, or when the steering wheel is turned more than a predetermined amount, that any or all of the air deflectors 10, 110, 30, 46 are retracted to avoid damage to the tractor 13, trailer or the deflectors. Further, it is contemplated that any or all of the deflectors 10, 110, 30, 46 could be spring-loaded so that if power failed, the deflectors would be automatically returned to the retracted position. It is also contemplated that as speed increases or decreases (above the predetermined speed), that the air deflectors 10, 110, 30, 46 would automatically extend. Further still, the deflectors 10, 110, 30, 46 can adjust independently, including each deflector 30, 46 on each side of the vehicle 14. It is also contemplated that the height adjustment can be optional to the method of FIG. 7.

With the adjustment of the air deflectors 10, 110, 30, 46 on a constant or periodic basis in response to the current air drag conditions on the vehicle 14, the amount of air drag on the vehicle improves. With improvements in the amount of air drag, there is increased fuel efficiency of the vehicle 14.

The present invention can be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method of changing the aerodynamic drag on a vehicle having at least one adjustable air deflector, comprising:
disposing an air drag sensor on an outside surface of the vehicle to measure an air drag value;
comparing the air drag value with a predetermined value; and
adjusting the air deflector when the air drag value is one of less than and less than or equal to the predetermined value.

2. The method of claim 1 wherein the air drag sensor measures the air drag value when the vehicle is at or exceeds a predetermined speed.

3. The method of claim 1 wherein a vehicle ride height is adjusted when the vehicle is at or exceeds a predetermined speed.

4. The method of claim 1 wherein the air drag sensor generally constantly measures the air drag value.

5. The method of claim 1 wherein the air drag sensor generally periodically measures the air drag value.

6. The method of claim 1 wherein the air deflector comprises a side air deflector that is moveable generally parallel to a longitudinal axis of the vehicle to close a gap between a tractor and a trailer of the vehicle.

7. The method of claim 1 wherein the air deflector comprises a side air deflector that is pivotable generally inwardly towards and outwardly away from a longitudinal axis of the vehicle.

8. The method of claim 1 wherein the air deflector comprises a roof air deflector that extends upwards away from a top surface of the vehicle.

9. The method of claim 1 wherein the air deflector comprises a plurality of air deflectors that are independently adjustable.

10. A method of changing the aerodynamic drag on a vehicle having adjustable air deflectors, comprising:
disposing an air drag sensor on an outside surface of the vehicle to measure an air drag value;
comparing the air drag value with a predetermined value; and
adjusting the air deflectors when the air drag value is one of greater than and greater than or equal to the predetermined value.

11. The method of claim 10 wherein the air drag sensor measures the air drag value when the vehicle is at or exceeds a predetermined speed.

12. The method of claim 10 wherein a vehicle ride height is adjusted when the vehicle is at or exceeds a predetermined speed.

13. The method of claim 10 wherein when a transmission of the vehicle is downshifted, the at least one air deflector is retracted.

14. The method of claim 10 wherein when brakes are applied more than a predetermined amount, the at least one air deflector is retracted.

15. The method of claim 10 wherein when a steering wheel is turned more than a predetermined amount, the at least one air deflector is retracted.

16. The method of claim 10 wherein the air drag sensor one of constantly and periodically measures the air drag value.

17. The method of claim 10 wherein the air deflector comprises a side air deflector that is moveable generally parallel with a longitudinal axis of the vehicle to close a gap between a tractor and a trailer of the vehicle.

18. The method of claim 10 wherein the air deflector comprises a side air deflector that is pivotable generally inwardly towards and outwardly away from a longitudinal axis of the vehicle.

19. The method of claim 10 wherein the air deflector comprises a side air deflector that is pivotable generally inwardly towards and outwardly away from a longitudinal axis of the vehicle.

20. A method of changing the aerodynamic drag on a vehicle having at least one adjustable air deflector, comprising:
comparing the vehicle speed with a predetermined speed;
adjusting the height of the vehicle when the vehicle speed is one of greater than or equal to or greater than the predetermined speed;
disposing an air drag sensor on an outside surface of the vehicle to measure an air drag value when the vehicle speed is one of greater than or equal to or greater than the predetermined speed;
comparing the air drag value with a predetermined value; and
adjusting the air deflector when the air drag value is one of less than and less than or equal to the predetermined value.
